(19) United States
(12) Patent Application Publication
(10) Pub. No.: US 2012/0223925 A1
(43) Pub. Date: Sep. 6, 2012

(54) PHOTODETECTION CIRCUIT, PHOTODETECTION METHOD, DISPLAY PANEL, AND DISPLAY

(75) Inventors: Tetsuro Yamamoto, Kanagawa (JP); Katsuhide Uchino, Kanagawa (JP)

(73) Assignee: Sony Corporation, Tokyo (JP)

(21) Appl. No.: 13/406,060

(22) Filed: Feb. 27, 2012

(30) Foreign Application Priority Data
Mar. 4, 2011 (JP) 2011-048320

(51) Int. Cl. G09G 5/00; G01J 1/46

(52) U.S. Cl. 345/207; 250/206

(57) ABSTRACT

There is provided a photodetection circuit and a photodetection method capable of obtaining high detection accuracy while reducing burn-in, and a display panel and a display including the above-described photodetection circuit. A photodetection circuit detecting incident light includes: a transistor provided between a fixed power supply line and a photodetection line; a photodiode provided between a gate of the transistor and a control line, and having a cathode directed toward the control line; a first capacitor connected, between the gate of the transistor and the control line, in parallel with the photodiode; and a second capacitor provided between the gate of the transistor and the fixed power supply line.

### BACKGROUND

The present technology relates to a photodetection circuit including a photodiode, and a photodetection method using the photodetection circuit. Moreover, the technology relates to a display panel including the above-described photodetection circuit and a display including the display panel.

In recent years, in the field of displays displaying an image, displays using, as light-emitting elements of pixels, current drive type optical elements of which light emission luminance changes depending on the value of current passing therethrough, for example, organic EL (electro luminescence) elements have been developed for commercialization. Unlike liquid crystal elements or the like, the organic EL elements are self-luminous elements. Therefore, in a display (an organic EL display) using the organic EL elements, as a light source (a backlight) is not necessary, compared to a liquid crystal display needing a light source, a reduction in the profile of the display and an increase in the luminance of the display are achievable. In particular, in the case where the display uses an active matrix system as a drive system, each pixel is allowed to continuously emit light, and a reduction in power consumption is achievable. Therefore, the organic EL display is expected to become a mainstream of next-generation flat panel display.

However, the organic EL element has an issue that the organic EL element is deteriorated according to the amount of current passing therethrough to cause a reduction in light emission efficiency (refer to FIG. 21). Therefore, in the case where the organic EL elements are used as pixels of a display, the degree of deterioration may vary from one pixel to another. For example, in the case where information such as time or a display channel is displayed with high luminance for a long time in the same region, deterioration of pixels in the region is accelerated. As a result, in the case where a picture with high luminance is displayed in a region including a pixel deteriorated faster, a phenomenon called burn-in in which only a region corresponding to the pixel is dark occurs. Burn-in is nonreversible; therefore, once burn-in occurs, burn-in does not disappear.

A large number of techniques of resolving burn-in by correcting the amount of current passing through organic EL elements have been proposed. For example, it is proposed that a photodiode is included in a pixel circuit. More specifically, as illustrated in FIG. 22, it is disclosed that in a pixel 100 (refer to FIG. 20) of a related art type configured of a pixel circuit 110 including a transistor T10, a transistor T20, and a retention capacitor C10, and an organic EL element 120, a photodiode D10 is included between a gate of the transistor T20 and a power supply line VCCL. Thus, when white is displayed, the photodiode detects light emission of the organic EL element to pass a current from a fixed power supply line to a gate of a transistor. At this time, a gate-source voltage of the transistor is reduced to reduce a current passing through the organic EL element. Next, the case where after a certain period of time, while white is displayed, light emission luminance is reduced due to a reduction in light emission efficiency of the organic EL element is considered. At this time, a reduction in light emission luminance causes a reduction in the amount of light entering the photodiode, and a reduction in the value of current flowing from the fixed power supply line to the gate of the transistor. Therefore, a gate-source voltage of the transistor is increased to increase a current passing through the organic EL element. When the amount of current passing through the organic EL element is adjusted by the photodiode in such a manner, burn-in caused by a change in efficiency of the organic EL element is allowed to be reduced.

Moreover, for example, it is proposed that a photodetection circuit is provided adjacent to the pixel circuit, and a signal processing circuit correcting a voltage level of a signal line in response to an output of the photodetection circuit is provided (refer to Japanese Unexamined Patent Application Publication No. 2010-286814). More specifically, as illustrated in FIG. 23, it is disclosed that a photodetection circuit 200 including a photodiode D2 and a switching transistor T2 which are connected to each other in series is provided between a photodetection line LDL and a power supply line VCCL, and a signal processing circuit (not illustrated) correcting a voltage level of a signal line DTL in response to an output of the photodetection circuit 200 is provided. Therefore, a voltage with consideration of degree of luminance degradation is allowed to be applied to the signal line DTL, thereby reducing burn-in caused by a change in efficiency of the organic EL element. Moreover, photodetection is allowed to be performed independently of luminance of a display image by performing photodetection in a period other than an image display period (for example, directly after turning off or on a power supply of a display).

### SUMMARY

In a technique described in Japanese Unexamined Patent Application Publication No. 2010-286814, to accurately detect a change in current, it is desirable to use an off region (an applied voltage: negative and around 0 V) where a change in current is large. However, even though the value of current at this time is large, the value of current is much smaller than an on-current. Therefore, there is an issue that sufficient luminance change detection accuracy is not allowed to be obtained.

It is desirable to provide a photodetection circuit and a photodetection method capable of obtaining high detection accuracy while reducing burn-in. Moreover, it is desirable to provide a display panel including the above-described detection circuit and a display including the display panel.

According to an embodiment of the technology, there is provided a first photodetection circuit detecting incident light. The photodetection circuit includes: a transistor provided between a fixed power supply line and a photodetection line; and a photodiode provided between a gate of the transistor and a control line, and having a cathode directed toward the control line. The photodetection circuit further includes: a first capacitor connected, between the gate of the transistor and the control line, in parallel with the photodiode; and a second capacitor provided between the gate of the transistor and the fixed power supply line.

According to an embodiment of the technology, there is provided a first display panel including: a plurality of pixels each including a self-luminous element; and a plurality of photodetection circuits detecting light emitted from the pixels. The photodetection circuits included in the display panel each include the same components as those included in the first photodetection circuit. According to an embodiment of the technology, there is provided a first display including: a display panel; and a drive circuit driving the display panel. The display panel included in the display includes the same components as those included in the first display panel.

In the first photodetection circuit, the first display panel, and the first display according to the embodiment of the technology, the photodiode has the cathode directed toward the control line, and the first capacitor is arranged in parallel with the photodiode. Therefore, a voltage corresponding to the amount of light emitted from a pixel is allowed to be applied as an on-voltage to the gate of the transistor connected to the photodetection line only by applying a control pulse to one control line.

According to an embodiment of the technology, there is provided a second photodetection circuit detecting incident light. The photodetection circuit includes: a transistor provided between a fixed power supply line and a photodetection line; and a photodiode provided between a gate of the transistor and a control line, and having a cathode directed toward the control line. The control line is connected to a power supply sequentially outputting three voltage values, i.e., a first voltage, a second voltage, and a third voltage. In this case, the first voltage is a voltage bringing a forward bias to the photodiode and turning off the transistor. The second voltage is a voltage bringing a reverse bias to the photodiode and turning off the transistor. The third voltage is a voltage bringing a reverse bias to the photodiode and turning on the transistor.

According to an embodiment of the technology, there is provided a second display panel including: a plurality of pixels each including a self-luminous element; and a plurality of photodetection circuits detecting light emitted from the pixels. The photodetection circuits included in the display panel each include the same components as those included in the second photodetection circuit. According to an embodiment of the technology, there is provided a second display including: a display panel; and a drive circuit driving the display panel. The display panel included in the display includes the same components as those included in the second display panel. Moreover, the drive circuit included in the display includes a power supply sequentially outputting the above-described three voltage values, i.e., the first voltage, the second voltage and the third voltage.

In the second photodetection circuit, the second display panel, and the second display according to the embodiment of the technology, the photodiode has the cathode directed toward the control line. Therefore, a voltage corresponding to the amount of light emitted from a pixel is allowed to be applied as an on-voltage to the gate of the transistor connected to the photodetection line only by applying a control pulse to one control line.

According to an embodiment of the technology, there is provided a photodetection method of detecting incident light with use of a photodetection circuit including a transistor and a photodiode, the transistor being provided between a fixed power supply line and a photodetection line, the photodiode being provided between a gate of the transistor and a control line and having a cathode directed toward the control line. The photodetection method includes the following three steps:

(A) providing the control line with a first voltage, and initializing a voltage level of the photodetection line, the first voltage bringing a forward bias to the photodiode and turning off the transistor;

(B) providing the control line with a second voltage, the second voltage bringing a reverse bias to the photodiode and turning off the transistor; and

(C) providing the control line with a third voltage, the third voltage bringing a reverse bias to the photodiode and turning on the transistor.

The photodetection method according to the embodiment of the technology may further include: initializing the voltage level of the photodetection line again between providing of the second voltage to the control line and providing of the third voltage to the control line.

In the photodetection method according to the embodiment of the technology, a voltage corresponding to the amount of light emitted from a pixel is allowed to be applied as an on-voltage to the gate of the transistor connected to the photodetection line only by applying a control pulse including three kinds of voltages to one control line with use of the photodetection circuit which includes the photodiode having the cathode directed toward the control line.

In the first and second photodetection circuits, the first and second display panels, the first and second displays, and the photodetection method according to the embodiment of the technology, a voltage corresponding to the amount of light emitted from a pixel is allowed to be applied as an on-voltage to the gate of the transistor connected to the photodetection line; therefore, while burn-in is reduced, high detection accuracy is allowed to be obtained.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is schematic configuration diagram of a display according to an embodiment of the technology.

FIG. 2 is a circuit diagram of a pixel in FIG. 1.

FIG. 3 is a circuit diagram of a photodetection circuit in FIG. 1.

FIG. 4 is a circuit diagram of a photodetection signal processing circuit in FIG. 1.

FIG. 5 is a diagram illustrating an operation relating to photodetection in the display in FIG. 1.

FIG. 6 is a diagram illustrating changes in potentials of a photodetection line and an A point (a gate of a transistor connected to the photodetection line) in photodetection in the display in FIG. 1.

FIG. 7 is a circuit diagram illustrating an example of an operation relating to photodetection in the display in FIG. 1.

FIG. 8 is a circuit diagram illustrating the operation following FIG. 7.

FIG. 9 is a circuit diagram illustrating the operation following FIG. 8.

FIG. 10 is a circuit diagram illustrating the operation following FIG. 9.

FIG. 11 is a circuit diagram illustrating the operation following FIG. 10.

FIG. 12 is a circuit diagram illustrating the operation following FIG. 11.

FIG. 13 is a circuit diagram of a modification of the photodetection circuit in FIG. 3.

FIG. 14 is a diagram illustrating an operation relating to photodetection in a display including the photodetection circuit in FIG. 13.

FIG. 15 is a circuit diagram of a first modification of the photodetection circuit in FIG. 13.

FIG. 16 is a circuit diagram of a second modification of the photodetection circuit in FIG. 13.

FIG. 17 is a circuit diagram of a third modification of the photodetection circuit in FIG. 13.

FIG. 18 is a schematic configuration diagram of an input device according to a reference example.

FIGS. 19A and 19B are diagrams illustrating states where information is entered into the input device in FIG. 18.

FIG. 20 is a circuit diagram of a pixel of a display in related art.

FIG. 21 is a plot illustrating changes with time in V-Ids characteristics of an organic EL element.

FIG. 22 is a circuit diagram of the pixel in FIG. 20 which is improved.

FIG. 23 is a circuit diagram of a photodetection circuit in related art.

FIG. 24 is a circuit diagram of the photodetection circuit in FIG. 23 which is improved, and a circuit diagram of a photodetection signal processing circuit detecting an output of the improved photodetection circuit.

FIG. 25 is a diagram illustrating an operation relating to photodetection in a display including the photodetection circuit and the photodetection signal processing circuit in FIG. 24.

FIG. 26 is a diagram illustrating changes in potentials of a photodetection line and a B point (a gate of a transistor connected to the photodetection line) in photodetection in the display including the photodetection circuit and the photodetection signal processing circuit in FIG. 24.

FIG. 27 is a circuit diagram illustrating an example of an operation relating to photodetection in the display including the photodetection circuit and the photodetection signal processing circuit in FIG. 24.

FIG. 28 is a circuit diagram illustrating the operation following FIG. 27.

FIG. 29 is a circuit diagram illustrating the operation following FIG. 28.

FIG. 30 is a circuit diagram illustrating the operation following FIG. 29.

FIG. 31 is a circuit diagram illustrating the operation following FIG. 30.

### DETAILED DESCRIPTION OF THE PREFERRED EMBODIMENTS

A preferred embodiment of the present technology will be described in detail referring to the accompanying drawings. It is to be noted that description will be given in the following order.

### 1. Embodiment (Display)

An example in which a drain of a transistor and an anode of a photodiode in a photodetection circuit are connected to different wiring lines, respectively

### 2. Modification (Display)

An example in which a drain of a transistor and an anode of a photodiode in a photodetection circuit are connected to a common wiring line

### 3. Reference Example (Input Device)

### 1. Embodiment

### [Configuration]

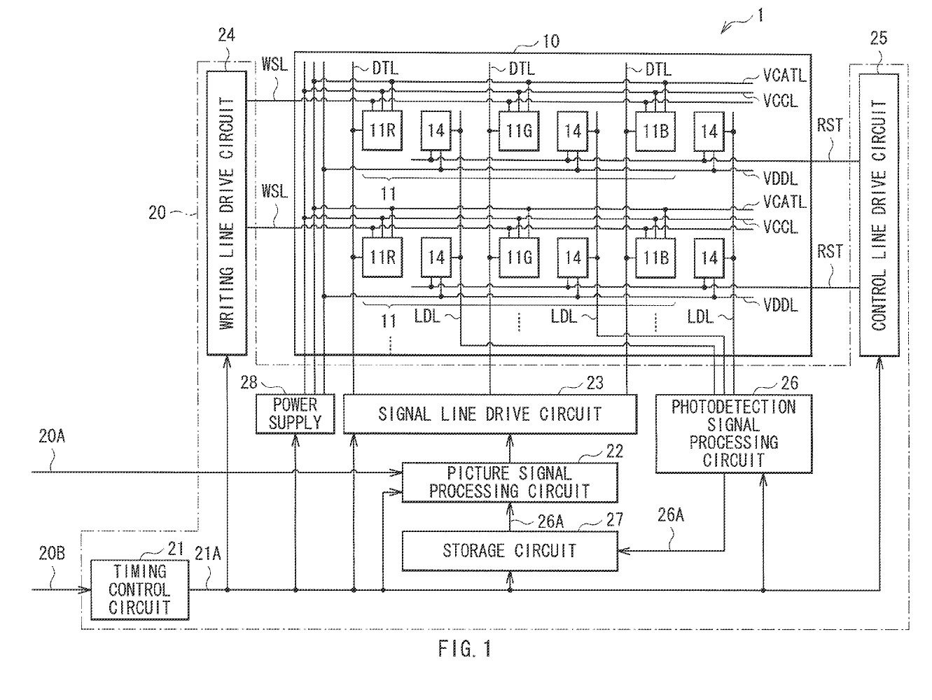

FIG. 1 illustrates an example of a whole configuration of a display 1 according to an embodiment of the technology. The display 1 includes a display panel 10 and a drive circuit 20 formed around the display panel 10.

### (Display Panel 10)

The display panel 10 includes a plurality of pixels 11 two-dimensionally arranged on an entire surface of the display panel 10. The display panel 10 displays an image based on a picture signal 20A supplied from an external device by driving respective pixels 11 in an active matrix mode. Each of the pixels 11 includes, for example, a red pixel 11R, a green pixel 11G, and a blue pixel 11B.

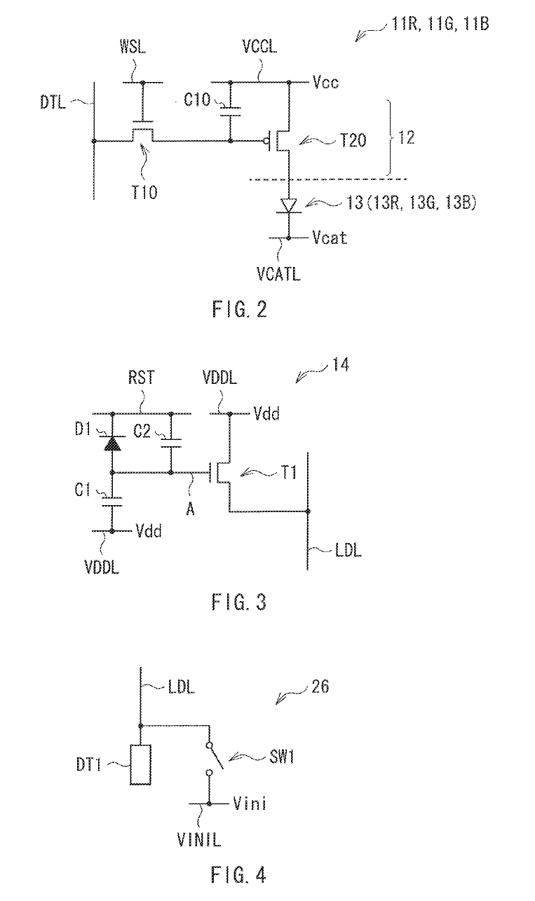

FIG. 2 illustrates an example of an internal configuration of each of the pixels 11R, 11G, and 11B. For example, as illustrated in FIG. 2, the pixels 11R, 11G, and 11B each include a pixel circuit 12 and organic EL elements 13R, 13G, and 13B, respectively. The organic EL elements 13R, 13G, and 13B are organic EL elements emitting red light, green light, and blue light, respectively. Hereinafter, the organic EL elements 13R, 13G, and 13B are collectively called “organic EL elements 13” as necessary. It is to be noted that the organic EL elements 13R, 13G, and 13B correspond to specific examples of “a self-luminous element” in the technology.

The organic EL element 13 has a configuration (not illustrated) formed by laminating an anode, an organic layer, and a cathode in order. The organic layer has a configuration formed by laminating a hole injection layer enhancing hole injection efficiency, a hole transport layer enhancing hole transport efficiency to a light-emitting layer, the light-emitting layer emitting light by the recombination of electrons and holes, and an electron transport layer enhancing electron transport efficiency to the light-emitting layer in order from the anode side.

For example, as illustrated in FIG. 2, the pixel circuit 12 includes transistors T10 and T20, and a retention capacitor C10. The transistor T10 samples a voltage level of a signal line DTL, and writes the voltage level to a gate of the transistor T20. The transistor T20 controls a current passing through the organic EL element 13 according to the magnitude of the voltage level written by the transistor T10. The retention capacitor C10 retains a predetermined voltage between the gate and a source of the transistor T20. The transistor T10 is configured of, for example, an n-channel MOS type thin film transistor (TFT). The transistor T20 is configured of, for example, a p-channel MOS type TFT. It is to be noted that the transistor T20 may be configured of an n-channel MOS type TFT.

The display panel 10 includes a plurality of writing lines WSL extending in a row direction, a plurality of signal lines DTL extending in a column direction, a plurality of power supply lines VCCL extending in the row direction, and a power supply line VCATL. The pixel 11R, the pixel 11G, or the pixel 11B is disposed around an intersection of each of the signal lines DTL and each of the writing lines WSL. Each of the signal lines DTL is connected to an output end (not illustrated) of a signal line drive circuit 23 which will be described later, and a source or a drain of the transistor T10. Each of the writing lines WSL is connected to an output end (not illustrated) of a writing line drive circuit 24 which will be described later, and a gate of the transistor T10. Each of the power supply lines VCCL is connected to an output end (not illustrated) of a power supply which outputs a fixed voltage Vcc, and is included in a power supply 28 which will be described later, and the source or a drain of the transistor T20. The power supply line VCATL is connected to a wiring line (not illustrated) with a voltage Vcat (for example, a ground potential) corresponding to a reference potential in the power supply 28 which will be described later, and the cathode of the organic EL element 13.

The gate of the transistor T10 is connected to the writing line WSL. The source or the drain of the transistor T10 is connected to the signal line DTL, and the source or the drain not connected to the signal line DTL of the transistor T10 is connected to the gate of the transistor T20. The source or the drain of the transistor T20 is connected to the power supply line VCCL, and the source or the drain not connected to the power supply line VCCL of the transistor T20 is connected to the anode of the organic EL element 13. An end of the retention capacitor C10 is connected to the gate of the transistor T20, and the other end of the retention capacitor C10 is connected to the source (a terminal on a side closer to the power supply line VCCL in FIG. 2) of the transistor T20. In other words, the retention capacitor C10 is inserted between the gate and the source of the transistor T20. The cathode of the organic EL element 13 is connected to the power supply line VCATL.

The drain of the transistor T10 is connected to the signal line DTL, and the source of the transistor T10 is connected to the gate of the transistor T20. The source of the transistor T20 is connected to the power supply line VCCL, and the drain of the transistor T20 is connected to the anode of the organic EL element 13. The cathode of the organic EL element 13 is connected to the power supply line VCATL.

The display panel 10 further includes a plurality of photodetection circuits 14 detecting light emitted from the pixel 11R, the pixel 11G, or the pixel 11B. The display panel 10 detects light emitted from the pixel 11R, the pixel 11G, or the pixel 11B by performing a line drive on the respective photodetection circuits 14. Each of the photodetection circuits 14 is disposed at a position where light emitted from the pixel 11R, the pixel 11G, or the pixel 11B is detectable, more specifically, adjacent to the pixel 11R, the pixel 11G, or the pixel 11B. One photodetection circuit 14 is provided to, for example, each pixel 11R, each pixel 11G, or each pixel 11B. It is to be noted that one photodetection circuit 14 may be provided for a plurality of pixels 11R, a plurality of pixels 11G, or a plurality of pixels 11B.

For example, as illustrated in FIG. 3, the photodetection circuits 14 each include a transistor T1, a photodiode D1, and capacitors C1 and C2. It is to be noted that the capacitor C1 corresponds to a specific example of “a second capacitor” in the technology, and the capacitor C2 corresponds to a specific example of “a first capacitor” in the technology. The transistor T1 outputs a detection signal to the photodetection line LDL. The photodiode D1 detects light emitted from the pixel 11R, the pixel 11G, or the pixel 11B. The capacitors C1 and C2 change a gate voltage of the transistor T1 according to a change in voltage level of a control line RST. The transistor T1 is configured of, for example, an n-channel MOS type TFT. It is to be noted that the transistor T1 may be configured of a p-channel MOS type TFT.

The display panel 10 includes a plurality of control lines RST extending in the row direction, a plurality of photodetection lines LDL extending in the column direction, and a plurality of power supply lines VDDL extending in the row direction. It is to be noted that the power supply line VDDL corresponds to a specific example of “a fixed power supply line” in the technology. Each of the photodetection circuits 14 is disposed around an intersection of each of the control lines RST and each of the photodetection lines LDL. Each of the control lines RST is connected to an output end (not illustrated) of a control line drive circuit 25 which will be described later, a cathode of the photodiode D1, and an end of the capacitor C2. Each of the photodetection lines LDL is connected to an output end (not illustrated) of a photodetection signal processing circuit 26 which will be described later, and a source or a drain of the transistor T1. Each of the power supply lines VDDL is connected to an output end (not illustrated) of a power supply which outputs a fixed voltage Vdd, and is included in the power supply 28 which will be described later, the source or the drain not connected to the photodetection line LDL of the transistor T1, and an end of the capacitor C1.

A gate of the transistor T1 is connected to an anode of the photodiode D1, and a connection point between the capacitor C1 and the capacitor C2. The source or the drain of the transistor T1 is connected to the power supply line VDDL, and the source or the drain not connected to the power supply line VDDL of the transistor T1 is connected to the photodetection line LDL. The cathode of the photodiode D1 is connected to the control line RST. An end of the capacitor C1 is connected to the gate of the transistor T1, and the other end of the capacitor C1 is connected to the power supply line VDDL. One end of the capacitor C2 is connected to the gate of the transistor T1, and the other end of the capacitor C2 is connected to the control line RST.

### (Drive Circuit 20)

For example, as illustrated in FIG. 1, the drive circuit 20 includes a timing control circuit 21, a picture signal processing circuit 22, the signal line drive circuit 23, the writing line drive circuit 24, and the control line drive circuit 25. For example, as illustrated in FIG. 1, the drive circuit 20 further includes the photodetection signal processing circuit 26, a storage circuit 27, and the power supply 28.

The timing control circuit 21 controls the picture signal processing circuit 22, the signal line drive circuit 23, the writing line drive circuit 24, the control line drive circuit 25, the photodetection signal processing circuit 26, the storage circuit 27, and the power supply 28 to operate in conjunction with one another. The timing control circuit 21 outputs a control signal 21A to each of the above-described circuits in response to (in synchronization with), for example, a synchronization signal 20B supplied from an external device.

The picture signal processing circuit 22 corrects a digital picture signal 20A supplied from an external device, and converts the corrected picture signal into an analog signal to output the analog signal to the signal line drive circuit 23. In the embodiment, the picture signal processing circuit 22 corrects the picture signal 20A with use of a correction factor 26A supplied from the storage circuit 27. For example, on activation of the display 1, the picture signal processing circuit 22 reads out the correction factor 26A from the storage circuit 27, and then multiplies the picture signal 20A by the read correction factor 26A to correct the picture signal 20A. At this time, the picture signal processing circuit 22 may weight the correction factor 26A according to the magnitude of gradation of the picture signal 20A (to be corrected) supplied from the external device to correct the picture signal 20A with use of the weighted correction factor 26A. It is to be noted that, for example, a table including a summary of a correspondence relationship between magnitude of gradation and a weighting degree may be stored in the storage circuit 27 or the like in advance, and on activation of the display 1, the picture signal processing circuit 22 may read out the table from the storage circuit 27.

It is to be noted that a timing of reading out the correction factor 26A from the storage circuit 27 is not limited to the time of activation of the display 1. For example, every time the correction factor 26A stored in the storage circuit 27 is updated in a period where a picture is displayed, the picture signal processing circuit 22 may read out the correction factor 26A from the storage circuit 27.

The signal line drive circuit 23 outputs an analog picture signal supplied from the picture signal processing circuit 22 to each signal line DTL in response to (in synchronization with) input of the control signal 21A. The writing line drive circuit 24 sequentially selects a predetermined number (for example, one) of writing lines WSL from the plurality of the writing lines WSL in response to (in synchronization with) input of the control signal 21A.

For example, the control line drive circuit 25 sequentially selects a predetermined number (for example, one) of control lines RST from the plurality of control lines RST in response to (in synchronization with) input of the control signal 21A. It is to be noted that in the case where the control line drive circuit 25 sequentially selects two or more control lines RST from the plurality of control lines RST, detection signals from the plurality of photodetection circuits 14 are collectively supplied to one photodetection line LDL.

The control line drive circuit 25 outputs a control pulse including three kinds of voltages as a selection signal to the control lines RST. More specifically, as a selection signal, the control line drive circuit 25 outputs, to the control lines RST, a control pulse including a first voltage (a voltage Vss) bringing a forward bias to the photodiode D1 and turning off the transistor T1, a second voltage (a voltage Vini) bringing a reverse bias to the photodiode D1 and turning off the transistor T1, and a third voltage (a voltage Vdd2) bringing a reverse bias to the photodiode D1 and turning on the transistor T1. Herein, the first voltage is lower than the second voltage and the third voltage, and is a voltage initializing a gate voltage of the transistor T1. The second voltage is higher than the first voltage and lower than the third voltage, and is a voltage to be applied to the photodiode D1 in photodetection. The third voltage is higher than the first voltage and the second voltage, and is a voltage for outputting a detection signal to the photodetection line LDL.

For example, as illustrated in FIG. 4, the photodetection signal processing circuit 26 includes a voltage detection section DT1 and a switch SW1. The voltage detection section DT1 detects a voltage level of the photodetection line LDL, and is connected to the photodetection line LDL. The switch SW1 initializes the voltage level of the photodetection line LDL. An end of the switch SW1 is connected to the photodetection line LDL, and the other end of the switch SW1 is connected to a power supply line VINIL. The power supply line VINIL is connected to an output end (not illustrated) of a power supply which outputs the fixed voltage Vini, and is included in the power supply 28 which will be described later.

The photodetection signal processing circuit 26 further includes a signal processing circuit (not illustrated) deriving the correction factor 26A in response to a photodetection signal 14A (an electrical signal) supplied from the photodetection circuit 14, and outputting the derived correction factor 26A to the storage circuit 27 in response to (in synchronization with) input of the control signal 21A.

The storage circuit 27 stores the correction factor 26A supplied from the photodetection signal processing circuit 26. The storage circuit 27 allows the picture signal processing circuit 22 to read out the stored correction factor 26A.

The power supply 28 supplies a fixed voltage to the display panel 10. The power supply 28 is configured of, for example, the power supply outputting the fixed voltage Vcc, the power supply outputting the fixed voltage Vdd, the power supply outputting the fixed voltage Vini, a wiring line with the voltage Vcat corresponding to a reference potential, and the like.

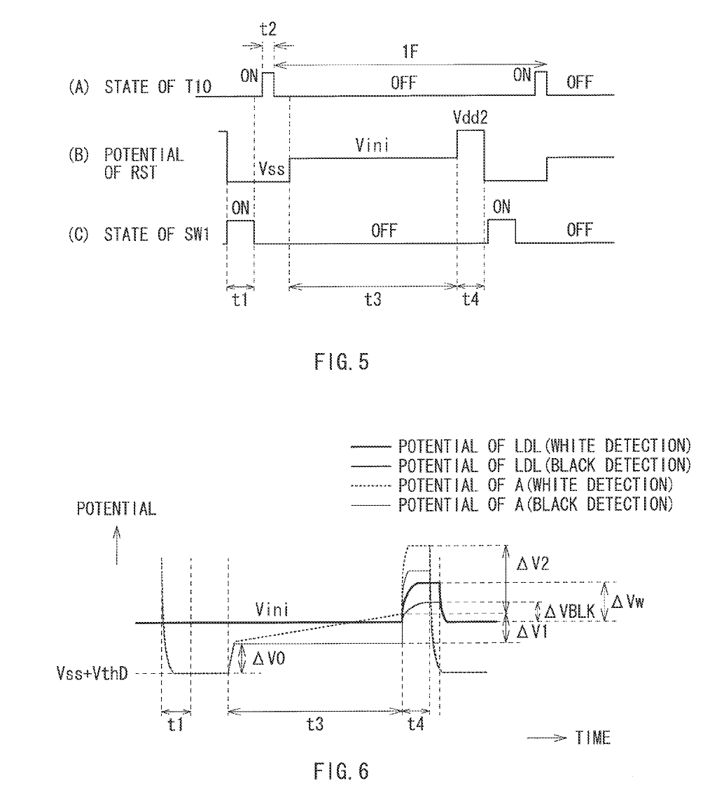

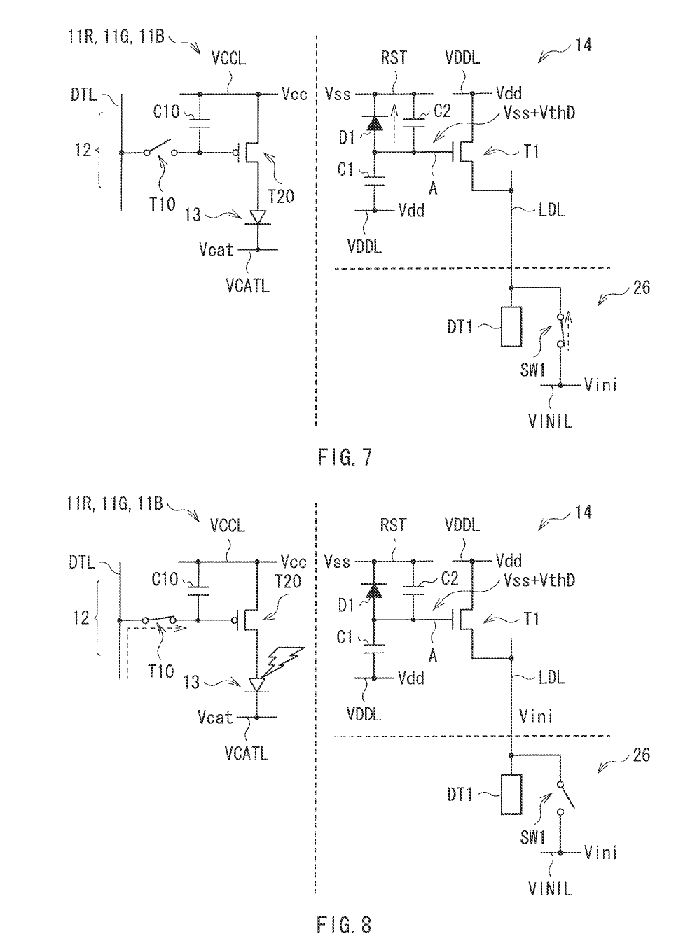

Next, referring to FIGS. 5 to 12, an operation of the photodetection circuit 14 will be described below. FIGS. 5 to 12 illustrate an example of the operation of the photodetection circuit 14. In FIGS. 5 and 6, as an example, a photodetection period is approximately 1 F. Herein, a part (A) in FIG. 5 illustrates an ON/OFF state of the transistor T10 in the pixel circuit 12 in FIG. 2. A part (B) in FIG. 5 illustrates a potential of the control line RST in the photodetection circuit 14 in FIG. 3. A part (C) in FIG. 5 illustrates a potential of the switch SW1 in the photodetection signal processing circuit 26 in FIG. 4. FIG. 6 illustrates a potential of the photodetection line LDL and a potential of the gate (an A point) of the transistor T1 in white detection and black detection. FIGS. 7 to 12 illustrate the operation of the photodetection circuit 14 with an operation of the pixel 11R, 11G, or 11B.

First, as illustrated in FIG. 7, the switch SW1 is turned on to change the potential of the photodetection line LDL to Vini. Moreover, the potential of the control line RST is changed to Vss which is an initialization potential. Therefore, the photodetection circuit 14 enters a detection preparation period t1, and when the gate potential of the transistor T1 is higher than Vss+VthD (where VthD is a threshold voltage of the photodiode D1), as illustrated in FIG. 7, a current flows, and the gate potential of the transistor T1 is initialized to a potential Vss+VthD. At this time, a gate-source potential of the transistor T1 is changed to Vss+VthD−Vini (<Vth1) (where Vth1 is a threshold voltage of the transistor T1), and the transistor T1 is in an OFF state. After a certain period of time, while the potential of the control line RST is kept at Vss, the switch SW1 is turned off.

Next, as illustrated in FIG. 8, the transistor T10 is turned on to input a signal voltage Vsig to the gate of the transistor T20 in the pixel circuit 12, thereby allowing the photodetection circuit 14 to enter a signal writing period t2. This operation allows a gate-source voltage of the transistor T20 to be equal to or higher than a threshold voltage of the transistor T20, and a current flows to the organic EL element 13 through the transistor T20, and the organic EL element 13 starts emitting light. At this time, as a voltage between terminals of the photodiode D1 is low, when time to a next step of changing the potential of the control line RST from Vss to Vini is reduced, a leakage current hardly flows to the photodiode D1.

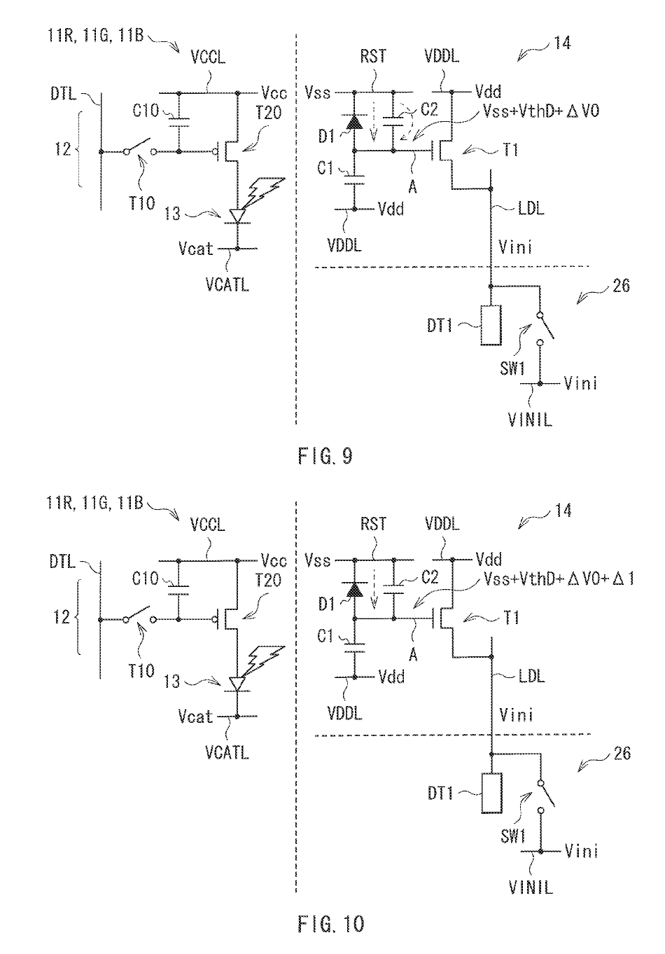

Next, the transistor T10 is turned off, and then, after a certain period of time, as illustrated in FIG. 9, the potential of the control line RST is changed from Vss to Vini which is a photodetection potential to allow the photodetection circuit 14 to enter a photodetection period t3. Accordingly, a potential change in the control line RST is supplied to the gate of the transistor T1 through the capacitor C2 to increase the gate potential of the transistor T1 to a potential Vss+VthD+ΔV0. As a result, as a potential difference Vss+VthD+ΔV0−Vini is generated in the photodiode D1, when light is detected, as illustrated in FIG. 9, a leakage current flows from the control line RST to the gate of the transistor T1. Accordingly, the gate potential of the transistor T1 is gradually increased. After a certain period of time, as illustrated in FIG. 10, the gate potential of the transistor T1 reaches a value Vss+VthD+ΔV0+ΔV1. At this time, the gate-source voltage of the transistor T1 is lower than the threshold voltage of the transistor T1; therefore, the transistor is still in the OFF state, and the potential of the photodetection line LDL is still kept at Vini.

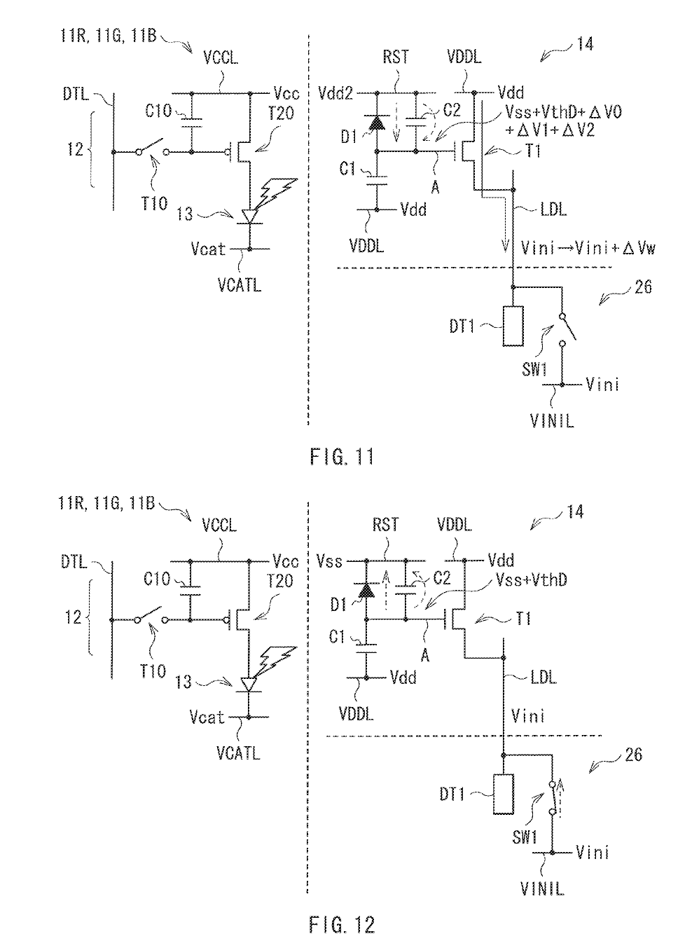

Next, as illustrated in FIG. 11, the potential of the control line RST is increased from Vini to Vdd2 to allow the photodetection circuit 14 to enter an output period t4. Thus, a potential change in the control line RST is supplied to the gate of the transistor T1 through the capacitor C2 to increase the gate potential of the transistor T1 to a potential Vini+VthD+ΔV1+ΔV2. At this time, when a gate-source voltage (ΔV2+Vss+VthD+ΔV0+ΔV1−Vini) of the transistor T1 is equal to or higher than the threshold voltage of the transistor T1, as illustrated in FIG. 11, a current flows from the power supply line VDDL, and the potential of the photodetection line LDL starts increasing. Then, after a certain period of time, the potential of the photodetection line LDL is changed to a potential Vini+ΔVw.

After that, as illustrated in FIG. 12, the potential of the control line RST is changed from Vdd2 to Vss to end the output period t4. Thus, a potential change in the control line RST is supplied again to the gate of the transistor T1 through the capacitor C2, and the gate potential of the transistor T1 is changed to Vss+VthD. As a result, the transistor T1 is turned off again. Lastly, as illustrated in FIG. 12, the switch SW1 is turned on to change the potential of the photodetection line LDL to Vini.

### [Effects]

Next, effects of the photodetection circuit 14 according to the embodiment will be described, compared to a comparative example.

An organic EL element has a characteristic that the organic EL element is deteriorated according to the amount of current passing therethrough to cause a reduction in light emission efficiency. Therefore, in the case where the organic EL elements are used as pixels of a display, the degree of deterioration may vary from one pixel to another. For example, in the case where information such as time or a display channel is displayed with high luminance for a long time in the same region, deterioration of pixels in the region is accelerated. As a result, in the case where a picture with high luminance is displayed in a region including a pixel deteriorated faster, a phenomenon called burn-in in which only a region corresponding to the pixel is dark occurs. Burn-in is nonreversible; therefore, once burn-in occurs, burn-in does not disappear.

A large number of techniques of resolving burn-in by correcting the amount of current passing through organic EL elements have been proposed. For example, it is proposed that a photodetection circuit is provided adjacent to a pixel circuit, and a signal processing circuit correcting a voltage level of a signal line in response to an output of the photodetection circuit is provided (refer to Japanese Unexamined Patent Application Publication No. 2010-286814). In the technique described in Japanese Unexamined Patent Application Publication No. 2010-286814, to accurately detect a change in current, it is necessary to use an off region (an applied voltage: negative and around 0 V) where a change in current is large. However, even though the value of current at this time is large, the value of current is much smaller than an on-current. Therefore, there is an issue that sufficient luminance change detection accuracy is not allowed to be obtained.

To accurately detects a change in luminance, it is necessary to increase time to charge a parasitic capacitance of the photodetection line LDL, and actually, unless a charging period is equal to or longer than 1 frame, it is difficult to accurately detect a change in current. Therefore, it is considered to increase the size of the photodiode D2 to increase the amount of current. However, when the size of the photodiode D2 is increased, an occupied area occupied by a photodetection circuit 200 is increased accordingly.

To resolve such an issue, it is considered to use a photodetection circuit 300 and a photodetection signal processing circuit 400 illustrated in FIG. 24. The photodetection circuit 300 includes a transistor T3 outputting a detection signal, a photodiode D3 detecting light, and a capacitor C3. The transistor T3 is provided between the photodetection line LDL and the power supply line VDDL. The photodiode D3 is arranged between a gate of the transistor T3 and the control line RST with an anode directed toward a gate of the transistor T3. The capacitor C3 is provided between the gate of the transistor T3 and a control line RWS. The photodetection signal processing circuit 400 includes a voltage detection section DT1 detecting a voltage supplied to the photodetection line LDL, the switch SW1 connected to the photodetection line LDL, and the power supply line VINIL connected to the photodetection line LDL through the switch SW1. The voltage detection section DT1 outputs a signal corresponding to a detected voltage to a signal processing circuit (not illustrated). The signal processing circuit corrects the magnitude of a voltage level provided to the signal line DTL according to the signal supplied from the voltage detection section DT1.

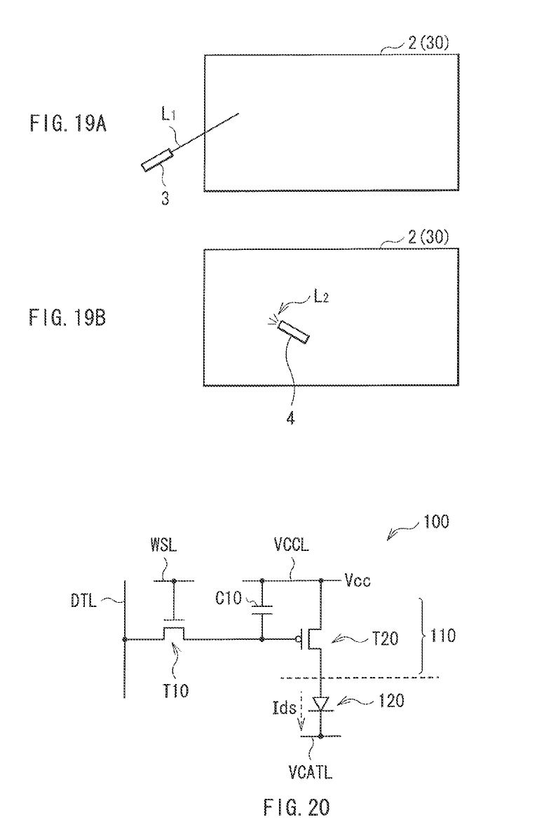

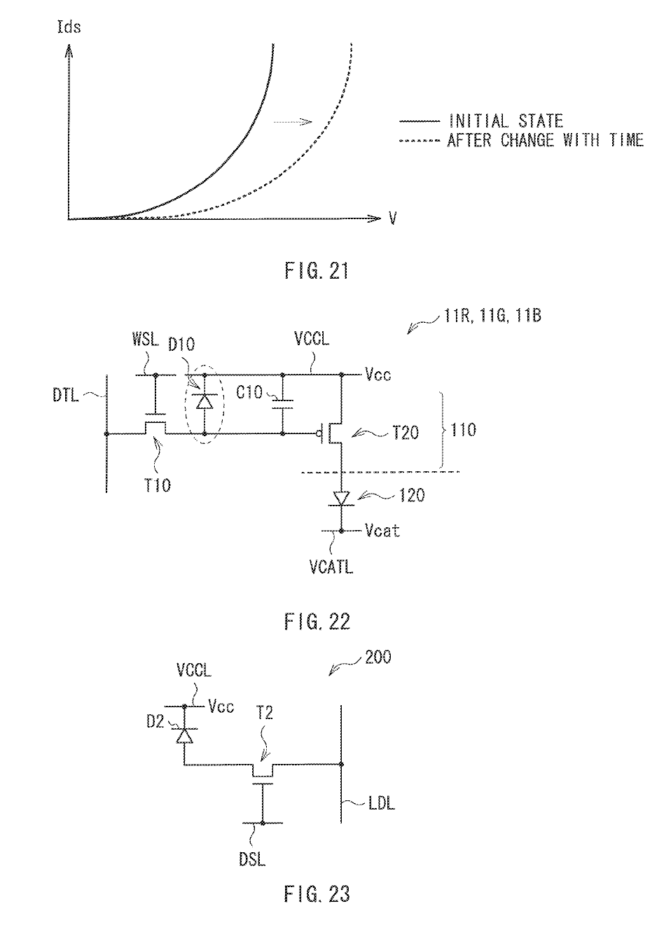

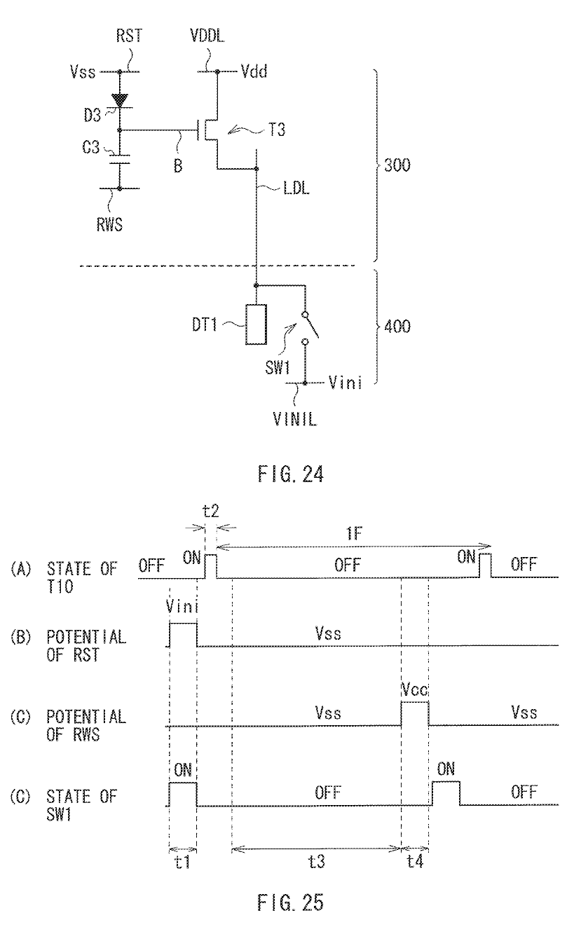

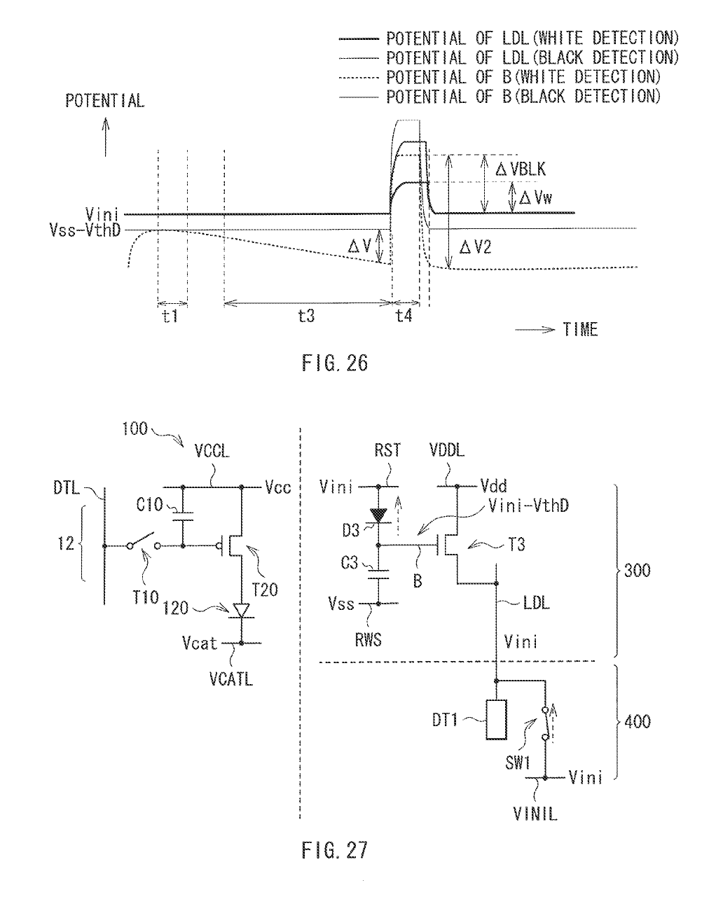

Next, referring to FIGS. 25 to 31, an operation of the photodetection circuit 300 will be described below. FIGS. 25 to 31 illustrate an example of the operation of the photodetection circuit 300. In FIGS. 25 and 26, as an example, a photodetection period is approximately 1F. Herein, a part (A) in FIG. 25 illustrates an ON/OFF state of the transistor T10 in the pixel 100 in FIG. 20. A part (B) in FIG. 25 illustrates a potential of the control line RST in the photodetection circuit 300 in FIG. 24. A part (C) in FIG. 25 illustrates a potential of the control line RWS in the photodetection circuit 300. A part (D) in FIG. 25 illustrates a potential of the switch SW1 in the photodetection signal processing circuit 400 in FIG. 24. FIG. 26 illustrates a potential of the photodetection line LDL and a potential of the gate (a B point) of the transistor T3 in white detection and black detection. FIGS. 27 to 31 illustrate the operation of the photodetection circuit 300 with an operation of the pixel 100.

First, as illustrated in FIG. 27, the potential of the control line RWS is changed to Vss, and the potential of the control line RST is changed to Vini. Moreover, the switch SW1 is turned on to change the potential of the photodetection line LDL to Vini. Therefore, the photodetection circuit 300 enters the detection preparation period t1, and when the gate potential of the transistor T3 is lower than Vini−VthD (where VthD is a threshold voltage of the photodiode D3), as illustrated in FIG. 26, a current flows, and the gate potential of the transistor T3 is initialized to a potential Vini−VthD. At this time, a gate-source potential of the transistor T3 is changed to −VthD, and the transistor T3 is in an OFF state. After a certain period of time, while the potential of the control line RST is kept at Vss, the switch SW1 is turned off.

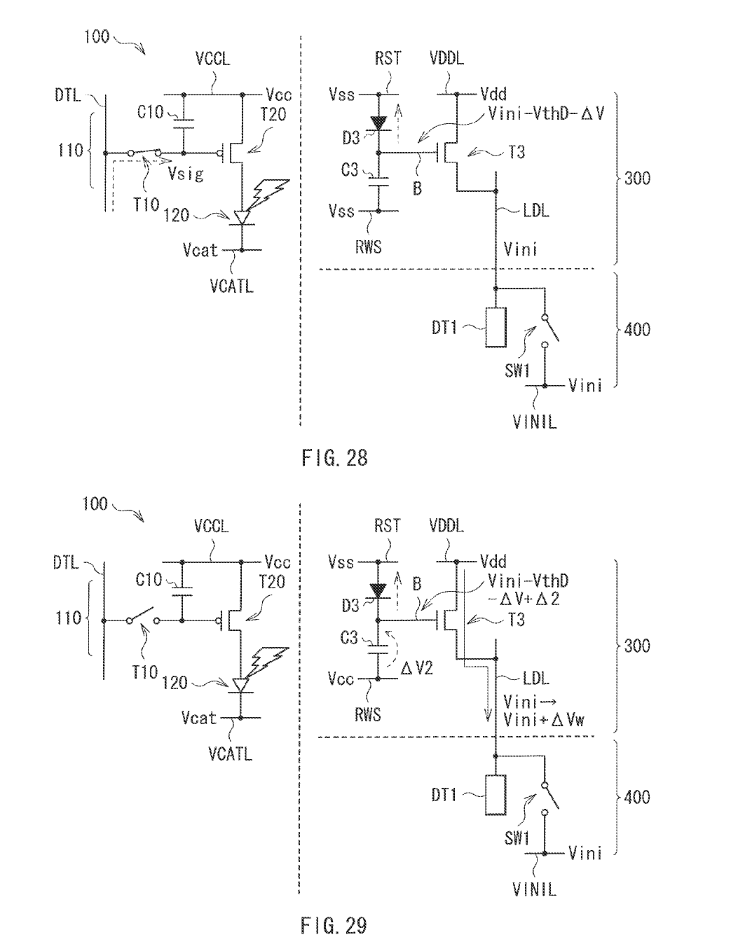

Next, as illustrated in FIG. 28, the transistor T10 is turned on to input a signal voltage Vsig to the gate of the transistor T20 in the pixel 100, thereby allowing the photodetection circuit 300 to enter the signal writing period t2. This operation allows the gate-source voltage of the transistor T20 to be equal to or higher than the threshold voltage of the transistor T20, and a current flows to the organic EL element 120 through the transistor T20, and the organic EL element 120 starts emitting light. Accordingly, the photodiode D3 detects light in a state where a potential difference is generated, and as illustrated in FIG. 28, a leakage current flows from the gate of the transistor T3 to the control line RST to gradually reduce the gate potential of the transistor T3. Next, after the transistor T10 is turned off, the photodetection circuit 300 enters the photodetection period t3, and after a certain period of time, the gate potential of the transistor T3 reaches a potential Vini−VthD−ΔV. At this time, the gate-source potential of the transistor T3 is changed to −VthD−ΔV; therefore, the transistor T3 is still in the OFF state, and the potential of the photodetection line LDL is still kept at Vini.

Next, as illustrated in FIG. 29, the potential of the control line RWS is increased from Vss to Vcc to allow the photodetection circuit 300 to enter the output period t4. Thus, a potential change in the control line RWS is supplied to the gate of the transistor T3 through the capacitor C3 to increase the gate potential of the transistor T3 to a potential Vini−VthD−ΔV+ΔV2. At this time, when a gate-source voltage (ΔV2−ΔV−VthD) of the transistor T3 is equal to or higher than the threshold voltage of the transistor T3, as illustrated in FIG. 26, a current flows from the power supply line VDDL, and the potential of the photodetection line LDL starts increasing. After a certain period of time, the potential of the photodetection line LDL is changed to a potential Vini+ΔVw.

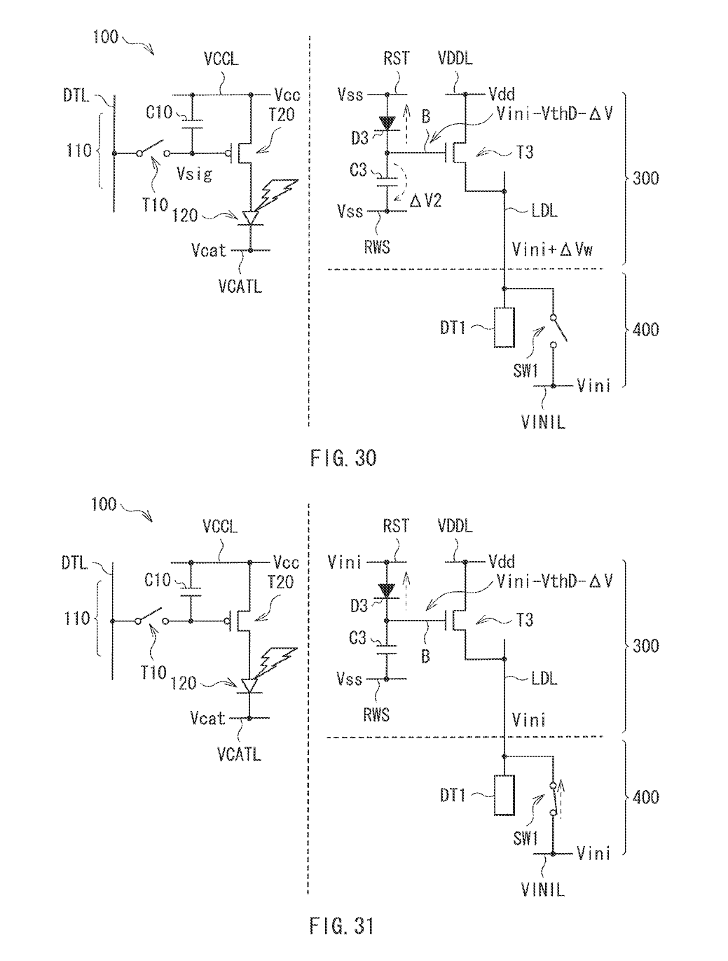

After that, as illustrated in FIG. 30, the potential of the control line RWS is changed from Vcc to Vss to end the output period t4. Thus, a potential change in the control line RWS is supplied again to the gate of the transistor T3 through the capacitor C3, and the gate potential of the transistor T3 is changed to Vini−VthD−ΔV. As a result, the transistor T3 is turned off again. Lastly, as illustrated in FIG. 31, the switch SW1 is turned on to change the potential of the photodetection line LDL to Vini.

Next, the case where the above-described operation is performed in white light emission detection and black light emission detection will be considered below. Typically, the larger the amount of light detected by a photodetection element is, the more amount of current passing through the photodetection element is increased. Therefore, the amount of change in the gate potential of the transistor T3 in white light emission detection is larger than that in black light emission detection. Therefore, the gate potential of the transistor T3 during output is higher in black light emission detection, and consequently, in black light emission detection, a higher voltage than that in white light emission detection is supplied to the photodetection line LDL. Therefore, a change in current is allowed to be detected accurately, and deficiencies in image quality such as burn-in are allowed to be resolved.

In the above-described photodetection circuit 300, four wiring lines, i.e., the power supply line VDDL, the control lines RST and RWS, and the photodetection line LDL are necessary. Typically, wiring lines such as a power supply line and a control line extend in a vertical direction or a horizontal direction of a display panel. Therefore, when the number of lines is large, an issue of a decline in yields such as a short circuit between lines is easily caused.

Next, in the photodetection circuit 14 according to the embodiment, the case where the above-described operation is performed in white light emission detection and in black light emission detection will be considered below. Also in this embodiment, as in the case of the above-described comparative example, the amount of change in the gate potential of the transistor T1 in white light emission detection is larger than that in black light emission detection. Therefore, the gate potential of the transistor T1 during output is higher in black light emission detection, and consequently, in black light emission detection, a higher voltage than that in white light emission detection is supplied to the photodetection line LDL. Thus, in the embodiment, a change in current is allowed to be detected accurately, and deficiencies in image quality such as burn-in are allowed to be resolved.

Moreover, in the embodiment, the photodiode D1 has the cathode directed toward the control line RST. Thus, a voltage corresponding to the amount of light emitted from the pixel 11R, 11G, or 11B as an on-voltage is applied to the gate of the transistor T1 connected to the photodetection line LDL only by applying the above-described control pulse to one control line RST. In other words, a voltage corresponding to the amount of light emitted from the pixel 11R, 11G, or 11B is allowed to be obtained by three wiring lines, i.e., one control line RST, one power supply line VDDL, and one photodetection line LDL. Therefore, burn-in is allowed to be reduced with a number of wiring lines one less than that in the photodetection circuit 300 illustrated in FIG. 24.

Further, in the embodiment, as the photodetection circuit 14 is allowed to be driven with a number of wiring lines one less than the number of wiring lines in the photodetection circuit 300 illustrated in FIG. 24; therefore, compared to the photodetection circuit 300, a possibility that an issue of a decline in yields such as a short circuit between wiring lines arises is allowed to be reduced.

Moreover, in the embodiment, in the case where two or more control lines RST are sequentially selected from the plurality of control lines RST, detection signals from a plurality of photodetection circuits 14 are supplied to one photodetection line LDL. It is to be noted that in the case where two or more control lines RST are sequentially selected from the plurality of control lines RST, for example, the two or more of control lines RST may be selected at the same time, or output periods of the two or more of control lines RST may overlap one another. Thus, the number of photodiodes D1 collectively used is allowed to be increased; therefore, photodetection accuracy is improvable.

### 2. Modifications

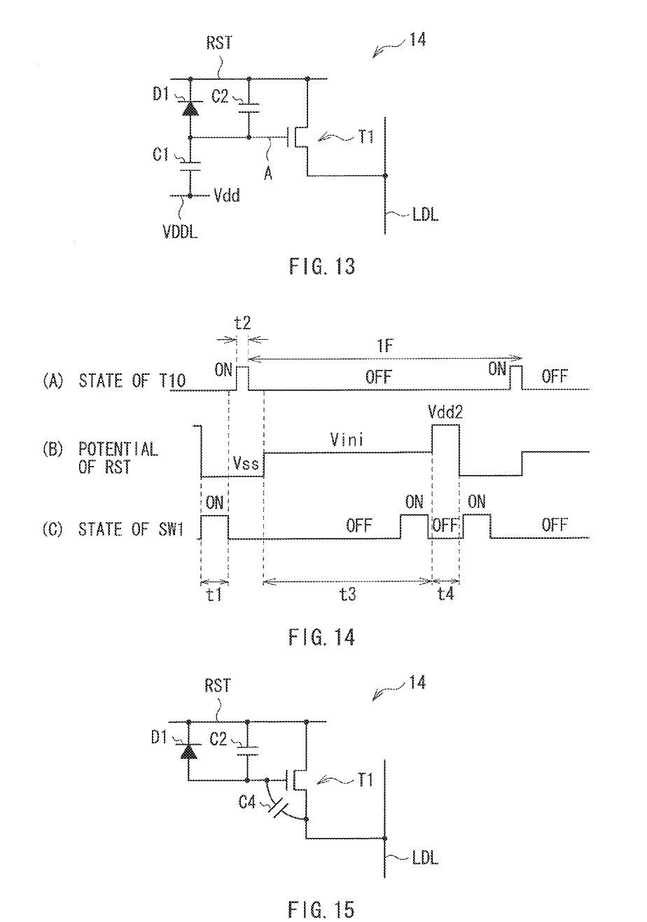

FIG. 13 illustrates a modification of the photodetection circuit 14 according to the above-described embodiment. In the photodetection circuit 14 according to the modification, the control line RST, instead of the power supply line VDDL, is connected to the transistor T1. A basic operation of the display 1 including the photodetection circuit 14 according to the modification is the same as that of the display 1 including the photodetection circuit 14 according to the above-described embodiment. In other words, the gate potential of the transistor T1 is initialized by changing the potential of the control line RST to Vss, and then, when the potential of the control line RST is changed to Vini, a potential difference is generated in the photodiode D1 in a state where the transistor T1 is off to perform photodetection. Lastly, the potential of the control line RST is changed to Vdd2 to turn on the transistor T1, thereby outputting a detection signal to the photodetection line LDL. However, in the modification, as variations in the gate voltage of the transistor T1 are supplied to the photodetection line LDL, for example, as illustrated in FIG. 14, it is necessary to initialize the potential of the photodetection line LDL to Vini immediately before the output period t4.

In the modification, as in the case of the embodiment, a voltage corresponding to the amount of light emitted from the pixel 11R, 11G, or 11B is allowed to be obtained with three wiring lines, i.e., one control line RST, one power supply line VDDL, and one photodetection line LDL. Therefore, burn-in is allowed to be reduced with a number of wiring lines one less than the number of wiring lines in the photodetection circuit 300 illustrated in FIG. 22. Moreover, in the modification, as in the case of the above-described embodiment, as the photodetection circuit 14 is allowed to be driven with a number of wiring lines one less than the number of wiring lines in the photodetection circuit 300 illustrated in FIG. 24, compared to the photodetection circuit 300, a possibility that an issue of a decline in yields such as a short circuit between wiring lines arises is allowed to be reduced. Further, also in the modification, in the case where two or more control lines RST are sequentially selected from the plurality of control lines RST, photodetection accuracy is allowed to be improved.

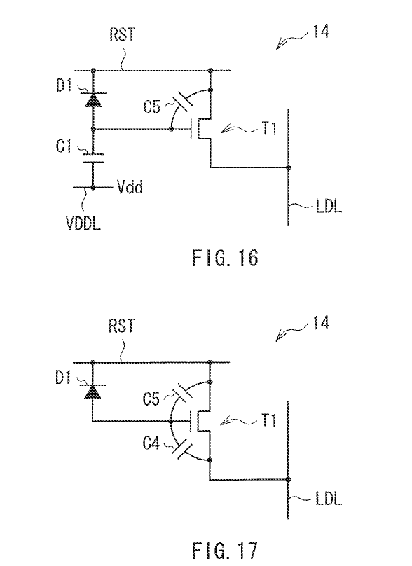

It is to be noted that in the modification, for example, as illustrated in FIG. 15, the capacitor C1 may be removed, and the parasitic capacitance C4 between the gate and the source of the transistor T1 may be allowed to function in a way similar to the capacitor C1. Moreover, in the modification, for example, as illustrated in FIG. 16, the capacitor C2 may be removed, and the parasitic capacitance C5 between the gate and the drain of the transistor T1 may be allowed to function in a way similar to the capacitor C2. Further, in the modification, for example, as illustrated in FIG. 17, the capacitors C1 and C2 may be removed, and the parasitic capacitance C4 between the gate and the source of the transistor T1 and the parasitic capacitance C5 between the gate and the drain of the transistor T1 may be allowed to function in ways similar to the capacitor C1 and the capacitor C2, respectively.

### 3. Reference Example

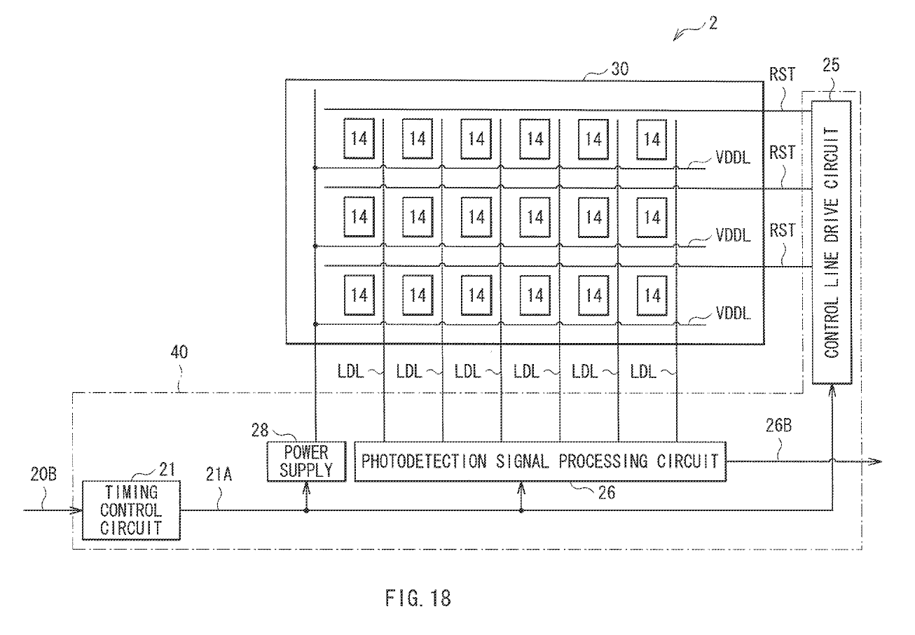

FIG. 18 illustrates an example of a whole configuration of an input device 2 according to a reference example. The input device 2 includes an input panel 30, and a drive circuit 40 formed around the input panel 30.

### (Input Panel 30)

The input panel 30 is configured by two-dimensionally arranging a plurality of photodetection circuits 14 on an entire surface of the input panel 30. The input panel 30 displays an image based on a picture signal 20A supplied from an external device by performing a line drive on respective photodetection circuits 14. The photodetection circuits 14 each have, for example, a configuration illustrated in FIG. 3, 13, 15, 16, or 17.

The input panel 30 includes a plurality of control lines RST extending in a row direction, a plurality of photodetection lines LDL extending in a column direction, and a plurality of power supply line VDDL extending in a row direction. Each of the photodetection circuits 14 is disposed around an intersection of each of the control lines RST and each of the photodetection lines LDL. In the case where the photodetection circuits 14 each have a configuration illustrated in FIG. 3, each of the control lines RST is connected to an output end (not illustrated) of the control line drive circuit 25, the cathode of the photodiode DE and an end of the capacitor C2. In the case where the photodetection circuits 14 each have a configuration illustrated in FIG. 13, 15, 16, or 17, each of the control lines RST is connected to an output end (not illustrated) of the control line drive circuit 25, the cathode of the photodiode D1, an end of the capacitor C2, and the source or the drain not connected to the photodetection line LDL of the transistor T1.

Each of the photodetection lines LDL is connected to an output end (not illustrated) of the photodetection signal processing circuit 26, and the source or the drain of the transistor T1. In the case where the photodetection circuits 14 each have the configuration illustrated in FIG. 3, each of the power supply lines VDDL is connected to an output end (not illustrated) of the power supply which outputs the fixed voltage Vdd, and is included in the power supply 28, the source or the drain not connected to the photodetection line LDL of the transistor T1, and an end of the capacitor C 1. In the case where the photodetection circuits 14 each have the configuration illustrated in FIG. 13, 15, 16, or 17, each of the power supply lines VDDL is connected to an output end (not illustrated) of the power supply which outputs the fixed voltage Vdd, and is included in the power supply 28, and an end of the capacitor C1.

### (Drive Circuit 40)

For example, as illustrated in FIG. 18, the drive circuit 40 includes the timing control circuit 21, the control line drive circuit 25, the photodetection signal processing circuit 26, and the power supply 28.

The timing control circuit 21 controls the control line drive circuit 25, the photodetection signal processing circuit 26, and the power supply 28 to operate in conjunction with one another. The timing control circuit 21 outputs the control signal 21A to each of the above-described circuits in response to (in synchronization with), for example, the synchronization signal 20B supplied from an external device.

For example, the control line drive circuit 25 sequentially selects a predetermined number (for example, one) of control lines RST from the plurality of control lines RST in response to (in synchronization with) input of the control signal 21A. It is to be noted that in the case where the control line drive circuit 25 sequentially selects two or more control lines RST from the plurality of control lines RST, detection signals from the plurality of photodetection circuits 14 are supplied to one photodetection line LDL.

As in the case of the above-described embodiment, the control line drive circuit 25 outputs a control pulse including three kinds of voltages as a selection signal to the control line RST. More specifically, as a selection signal, the control line drive circuit 25 outputs, to the control line RST, a control pulse including the first voltage bringing a forward bias to the photodiode D1 and turning off the transistor T1, the second voltage bringing a reverse bias to the photodiode D1 and turning off the transistor T1, and the third voltage bringing a reverse bias to the photodiode D1 and turning on the transistor T1.

For example, as illustrated in FIG. 4, the photodetection signal processing circuit 26 includes the voltage detection section DT1 and the switch SW1. The photodetection signal processing circuit 26 further includes a signal processing circuit (not illustrated) deriving a position, on the input panel 30, of a light emission spot formed by incident light in response to the photodetection signal 14A (an electrical signal) supplied from the photodetection circuit 14, and outputting derived position information 26B to an external device in response to (in synchronization with) input of the control signal 21A.

The power supply 28 supplies a fixed voltage to the input panel 30. The power supply 28 is configured of, for example, the power supply outputting the fixed voltage Vdd, and the like.

Next, referring to FIG. 19, an operation of the input device 2 will be described below. A part (A) in FIG. 19 schematically illustrates a state where predetermined information is supplied to the input device 2 by applying laser light L1 of a laser pointer 3 to the input panel 30 of the input device 2. A part (B) in FIG. 19 schematically illustrates a state where predetermined information is supplied to the input device 2 by bringing an end of a penlight 4 of which only the end emits light into contact with the input panel 30 of the input device 2, and applying light L2 of the penlight 4 to the input panel 30. Examples of the predetermined information supplied to the input device 2 include characters, symbols, and images.

In the reference example, the laser point 3, the penlight 4, or the like applies light to the input panel 30 of the input device 2, and a light emission spot formed on the input panel 30 is moved on a surface of the input panel 30 to output position information 26B of the light emission spot. Then, when the position information 26B is accumulated in an information processing device (not illustrated), information such as characters, symbols or images is allowed to be obtained.

In the reference example, in the case where resolution for detecting incident light smaller than the total number (resolution) of the photodetection circuits 14 included in the input panel 30 does not cause an issue, two or more control lines RST may be sequentially selected from the plurality of control lines RST. It is to be noted that as a method of sequentially selecting two or more control lines RST from the plurality of control lines RST, for example, two or more of control lines RST may be selected at the same timing, or output periods of two or more of control lines RST may overlap one another. In such a case, as detection signals from a plurality of photodetection circuits 14 are supplied to one photodetection line LDL, the number of photodiodes D1 collectively used is allowed to be increased, and photodetection accuracy is allowed to be improved.

The present application contains subject matter related to that disclosed in Japanese Priority Patent Application 2011-048320 filed in the Japan Patent Office on Mar. 4, 2011, the entire content of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. A photodetection circuit detecting incident light, comprising:
a transistor provided between a fixed power supply line and a photodetection line;
a photodiode provided between a gate of the transistor and a control line, and having a cathode directed toward the control line;
a first capacitor connected, between the gate of the transistor and the control line, in parallel with the photodiode; and
a second capacitor provided between the gate of the transistor and the fixed power supply line.

2. The photodetection circuit according to claim 1, wherein
the control line is connected to a power supply sequentially outputting a first voltage, a second voltage, and a third voltage, the first voltage bringing a forward bias to the photodiode and turning off the transistor, the second voltage bringing a reverse bias to the photodiode and turning off the transistor, the third voltage bringing a reverse bias to the photodiode and turning on the transistor.

3. A photodetection circuit detecting incident light, comprising:
a transistor provided between a fixed power supply line and a photodetection line; and
a photodiode provided between a gate of the transistor and a control line, and having a cathode directed toward the control line,
wherein the control line is connected to a power supply sequentially outputting a first voltage, a second voltage, and a third voltage, the first voltage bringing a forward bias to the photodiode and turning off the transistor, the second voltage bringing a reverse bias to the photodiode and turning off the transistor, the third voltage bringing a reverse bias to the photodiode and turning on the transistor.

4. The photodetection circuit according to claim 3, further comprising a first capacitor connected, between the gate of the transistor and the control line, in parallel with the photodiode.

5. The photodetection circuit according to claim 3, further comprising a second capacitor provided between the gate of the transistor and the fixed power supply line.

6. A display panel comprising:
a plurality of pixels each including a self-luminous element; and
a plurality of photodetection circuits detecting light emitted from the pixels,
wherein the photodetection circuits each include:
a transistor provided between a fixed power supply line and a photodetection line,
a photodiode provided between a gate of the transistor and a control line, and having a cathode directed toward the control line,
a first capacitor connected, between the gate of the transistor and the control line, in parallel with the photodiode, and
a second capacitor provided between the gate of the transistor and the fixed power supply line.

7. A display panel comprising:
a plurality of pixels each including a self-luminous element; and
a plurality of photodetection circuits detecting light emitted from the pixels,
wherein the photodetection circuits each include:
a transistor provided between a fixed power supply line and a photodetection line, and
a photodiode provided between a gate of the transistor and a control line, and having a cathode directed toward the control line, and
the control line is connected to a power supply sequentially outputting a first voltage, a second voltage, and a third voltage, the first voltage bringing a forward bias to the photodiode and turning off the transistor, the second voltage bringing a reverse bias to the photodiode and turning off the transistor, the third voltage bringing a reverse bias to the photodiode and turning on the transistor.

8. A display comprising:
a display panel; and
a drive circuit driving the display panel,
wherein the display panel includes:
a plurality of pixels each including a self-luminous element, and
a plurality of photodetection circuits detecting light emitted from the pixels, and
the photodetection circuits each include:
a transistor provided between a fixed power supply line and a photodetection line,
a photodiode provided between a gate of the transistor and a control line, and having a cathode directed toward the control line,
a first capacitor connected, between the gate of the transistor and the control line, in parallel with the photodiode, and
a second capacitor provided between the gate of the transistor and the fixed power supply line.

9. The display according to claim 8, wherein
the drive circuit includes a power supply sequentially outputting a first voltage, a second voltage, and a third voltage to the control line, the first voltage bringing a forward bias to the photodiode and turning off the transistor, the second voltage bringing a reverse bias to the photodiode and turning off the transistor, the third voltage bringing a reverse bias to the photodiode and turning on the transistor.

10. The display according to claim 8, wherein
the drive circuit includes a photodetection signal processing circuit connected to the photodetection line, the photodetection signal processing circuit including:
a voltage detection section detecting a voltage level of the photodetection line, and
an initialization section initializing the voltage level of the photodetection line.

11. The display according to claim 10, wherein
the drive circuit further includes a signal processing circuit correcting a picture signal according to the magnitude of the voltage level detected by the voltage detection section.

12. A display comprising:
a display panel; and
a drive circuit driving the display panel,
wherein the display panel includes:
a plurality of pixels each including a self-luminous element, and
a plurality of photodetection circuits detecting light emitted from the pixels, and
the photodetection circuits each include:
a transistor provided between a fixed power supply line and a photodetection line, and
a photodiode provided between a gate of the transistor and a control line, and having a cathode directed toward the control line, and
the drive circuit includes a power supply sequentially outputting a first voltage, a second voltage, and a third voltage to the control line, the first voltage bringing a forward bias to the photodiode and turning off the transistor, the second voltage bringing a reverse bias to the photodiode and turning off the transistor, the third voltage bringing a reverse bias to the photodiode and turning on the transistor.

13. The display according to claim 12, wherein
the drive circuit further includes a photodetection signal processing circuit connected to the photodetection line, the photodetection signal processing circuit including:
a voltage detection section detecting a voltage level of the photodetection line, and
an initialization section initializing the voltage level of the photodetection line.

14. The display according to claim 13, wherein
the drive circuit further includes a signal processing circuit correcting a picture signal according to the magnitude of the voltage level detected by the voltage detection section.

15. A photodetection method of detecting incident light with use of a photodetection circuit including a transistor and a photodiode, the transistor being provided between a fixed power supply line and a photodetection line, the photodiode being provided between a gate of the transistor and a control line and having a cathode directed toward the control line, the photodetection method comprising:
providing the control line with a first voltage, and initializing a voltage level of the photodetection line, the first voltage bringing a forward bias to the photodiode and turning off the transistor;
providing the control line with a second voltage, the second voltage bringing a reverse bias to the photodiode and turning off the transistor; and
providing the control line with a third voltage, the third voltage bringing a reverse bias to the photodiode and turning on the transistor.

16. The photodetection method according to claim 15, further comprising:
initializing the voltage level of the photodetection line again between providing of the second voltage to the control line and providing of the third voltage to the control line.
